(19) United States
(12) Patent Application Publication
(10) Pub. No.: US 2014/0368048 A1
(43) Pub. Date: Dec. 18, 2014

(54) WIRELESS CHARGING WITH REFLECTORS

(71) Applicant: DvineWave Inc., San Ramon, CA (US)

(72) Inventors: Michael A. Leabman, San Ramon, CA (US); Gregory Scott Brewer, Livermore, CA (US)

(21) Appl. No.: 13/916,233

(22) Filed: Jun. 12, 2013

(51) Int. Cl. H02J 7/02; H02J 17/00

(52) U.S. Cl. CPC H02J 7/025; H02J 17/00
USPC 307/104

(57) ABSTRACT

A wireless power transmission method may employ pocket forming in combination with one or more reflectors for redirecting the formation of pockets of energy towards one or more locations or electronic devices of interest. A transmitter can be purposely aimed at the reflector which can then redirect the transmitted RF waves towards a receiver embedded or operatively coupled to the electronic device. These reflectors can be installed in the room ceiling, walls, or floor, in relation to the position of the transmitter and the electronic device. Reflectors can be made of metallic materials capable of reflecting RF waves and can exhibit various configurations, shapes, sizes and surface textures, according to the application.

### CROSS-REFERENCES TO RELATED APPLICATIONS

The present disclosure is related to U.S. Non-Provisional patent application Ser. No. 13/891,399 filed May 10, 2013, entitled “Receivers For Wireless Power Transmission”; Ser. No. 13/891,430 filed May 10, 2013, entitled “Methodology For Pocket-forming” and Ser. No. 13/891,455 filed May 10, 2013, entitled “Transmitters For Wireless Power Transmission”, the entire contents of Which are incorporated herein by these references.

### FIELD OF INVENTION

The present disclosure relates generally to wireless power transmission, and more particularly, to a method for wireless power transmission based on pocket forming and reflectors.

### BACKGROUND OF THE INVENTION

Electronic devices such as laptop computers, smartphones, portable gaming devices, tablets and so forth may require power for performing their intended functions. This may require having to charge electronic equipment at least once a day, or in the case of high-demand electronic devices, more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging.

Wireless power transmission may represent an option for charging electronic devices without the use of cables, connectors, or power mats. Specifically, wireless power transmission may employ a pocket forming technique for charging electronic devices. In this method, a receiver can generate an omnidirectional signal that can be intercepted by a transmitter. A micro-controller embedded in the transmitter may decode the signal and may identity the gain and phase from the signal sent by the receiver, establishing a channel or path between the transmitter and receiver. Once the channel is established, the transmitter may transmit controlled Radio Frequency (RF) waves which may converge in 3-d space. These RF waves may be controlled through phase and/or relative amplitude adjustments to form constructive and destructive interference patterns (pocket-forming). A receiver embedded or operatively coupled with the electronic device may then utilize pockets of energy for charging or powering an electronic device.

This method of wireless charging may require the use of room structures such as walls, ceilings or floors for reflecting RF waves from the transmitter towards the receiver in the electronic device, according to the established communication path. However, typical materials used in these room structures are not good reflectors as a portion of the RF waves can be absorbed or can go through the walls, ceilings or floor. This may limit reflection efficiency, thereby reducing the magnitude of power transfer through the generation of pockets of energy.

For the foregoing reasons, there may be a need for a wireless charging method that may decrease the power losses in the reflected RF waves for enhancing the wireless powering or charging efficiency of one or more electronic devices.

### SUMMARY OF THE INVENTION

A wireless power transmission method may include one or more reflectors that can redirect the formation of pockets of energy to one or more locations, for the powering or charging of one or more electronic devices.

A wireless power transmission method based on pocket forming may include a transmitter that may generate radio frequency (RF) waves, where these RF waves may be controlled and configured for forming constructive and destructive interference patterns. A receiver, embedded or operatively coupled to an electronic device, may receive the transmitted RF waves, where pockets of energy may be formed at constructive interference patterns, while null-spaces may be generated at destructive interference patterns. The receiver may then utilize these pockets of energy for powering or charging the electronic device.

According to an embodiment, a wireless power transmission based on pocket forming may include a reflector for redirecting the transmitted RF waves to the location of an electronic device. This reflector can be made of metallic materials such as steel, aluminum, copper, and the like, so as to reflect nearly 100% of the RF waves' power directly towards the receiver in the electronic device for the formation of pockets of energy that may provide suitable powering or charging.

In another embodiment, wireless power transmission may utilize pocket-forming in conjunction with a plurality of reflectors for redirecting the formation of pockets of energy to one or more electronic devices in different locations. The transmitter can be purposely aimed at the reflectors, where the reflectors can be installed in the room ceiling, walls, or floor, according to relative position of the transmitter and the electronic devices to be powered or charged.

Yet in another embodiment, a reflector structure may include one or more reflector pieces that can be angled independently to redirect the formation of pockets of energy to one or more electronic devices in different locations. The transmitter can be aimed at any of these reflector pieces to redirect pocket-forming to a desired location depending on the orientation of the reflector pieces. In another embodiment, one or more transmitters or a transmitter capable of multiple-pocket forming can work in conjunction with multiple reflectors or reflector structure to provide power or charge to multiple electronic devices in different locations at the same time.

Reflector configurations can be in different shapes, sizes and surface textures. In some embodiments, a reflector can exhibit rectangular or oval planar shape, with smooth or uneven surface texture, according to the application. Yet in another embodiment, a reflector may exhibit a pyramid shape.

In further embodiments, a suitable reflector can he implemented using insulation films that may be typically installed in room windows, where these insulation films can include a transparent metallic layer which can reflect RF waves towards a particular location or electronic device of interest. A suitable reflector can also be implemented through the use of metallic paints, and the like.

The disclosed wireless power transmission method using pocket forming in combination with reflectors can avoid interference or power loss from obstacles or room structures, thereby improving the spatial 3-dimensional pocket formation, while increasing the power transmission efficiency from the transmitter to the receiver in the electronic device of interest. Additional features and advantages can become apparent from the detailed descriptions which follow, taken in conjunction with the accompanying drawings.

### BRIEF DESCRIPTION OF THE DRAWINGS

Embodiments of the present disclosure are described by way of example with reference to the accompanying figures which are schematic and may not be drawn to scale. Unless indicated as representing the background information, the figures represent aspects of the invention.

FIG. 1 shows a wireless power transmission using pocket forming.

FIG. 2 illustrates a wireless power transmission using adaptive pocket-forming, where reflected RF waves can he absorbed by or can go through the room structures.

FIG. 3 depicts a wireless power transmission that may employ pocket-forming in combination with a reflector for improving power transmission and charging efficiency.

FIG. 4 illustrates a wireless power transmission that may utilize pocket-forming in combination with a plurality of reflectors for improving power transmission and charging efficiency.

FIG. 5 shows a reflector structure that can include one or more reflector pieces which can be independently aligned for reflecting RF waves in different directions during a wireless power transmission.

FIG. 6 depicts reflector configurations that can be used during a wireless power transmission.

FIG. 7 illustrates a wireless power transmission that may include a window reflector for improving power transmission and charging efficiency.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

“Reflector” may refer to a device capable of efficiently reflecting the power of RF waves from a transmitter towards a receiver for the wireless charging of an electronic device.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments can be used and/or and other changes can be made without departing from the spirit or scope of the present disclosure.

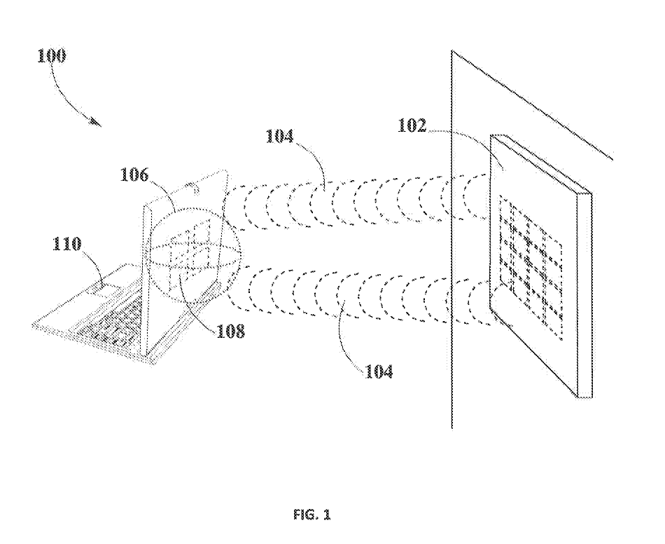

FIG. 1 illustrates a wireless power transmission 100 using pocket-forming. A transmitter 102 may transmit controlled radio frequency (RF) waves 104 which may converge in 3-d space. These RF waves 104 may be controlled through phase and/or relative amplitude adjustments to form constructive and destructive interference patterns (pocket-forming). Pockets of energy 106 may be formed at constructive interference patterns and can be 3-dimensional in shape, whereas mill-spaces may be generated at destructive interference patterns. A receiver 108 may then utilize pockets of energy 106 produced by pocket-forming for charging or powering an electronic device 110, for example, a smartphone, a tablet, a laptop computer (as shown in FIG. 1), a music player, an electronic toy, and the like. In some embodiments, there can be multiple transmitters 102 and/or multiple receivers 108 for powering various electronic devices 110 at the same time. In other embodiments, adaptive pocket-forming may be used to regulate power on electronic devices.

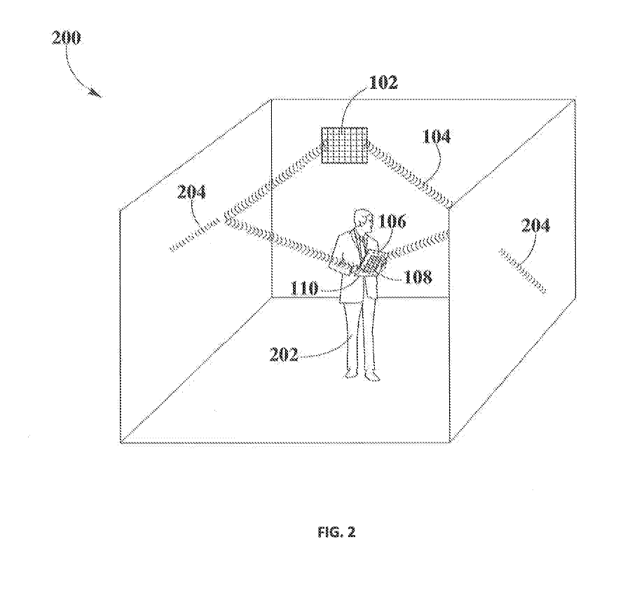

Referring now to FIG. 2, an exemplary illustration of a wireless power transmission 200 using adaptive pocket-forming can include a user 202 inside a room holding an electronic device 110 which may include a receiver 108 either embedded or as a separate adapter. A transmitter 102 may be hanging on one of the walls of the room behind user 202, as shown in FIG. 2. As user 202 may seem to be obstructing the path. between receiver 108 and transmitter 102, RF waves 104 may not be easily aimed to receiver 108 in a linear direction.

Given that the signals generated from receiver 108 may be omnidirectional (according to the type of antenna elements used), these signals may bounce over the walls, floor, and/or ceiling until they find transmitter 102. Almost instantly, a micro-controller (not shown in FIG. 2) which may reside in transmitter 102, may recalibrate the signals sent by receiver 108 by adjusting gain and phases, forming conjugates taking into account the built-in phases of antenna elements. Once calibration is performed, transmitter 102 may focus RF waves 104 in one or more channels following one or more paths as described in FIG. 2. Subsequently, a pocket of energy 106 may be generated on electronic device 110 while avoiding obstacles such as user 202 or any room furniture such as chairs, tables, and sofas (not shown in FIG. 2.).

While wireless power transmission 200 is illustrated as using the room wails to reflect the transmitted RF waves 104 towards receiver 108, other room structures such as ceiling or floor may also be used for this purpose. However, depending on the thickness and materials used in the room walls, ceiling or floor, the reflected RF waves 104 can lose significant signal power as they can go through or be absorbed by these structures. For example, as shown in FIG. 2, if a portion 204 of RF waves 104 goes through room walls made of wood, cement or plaster; the signal power of RF waves 104 reaching receiver 108 can be decreased to up to about 50%, thereby negatively affecting charging efficiency.

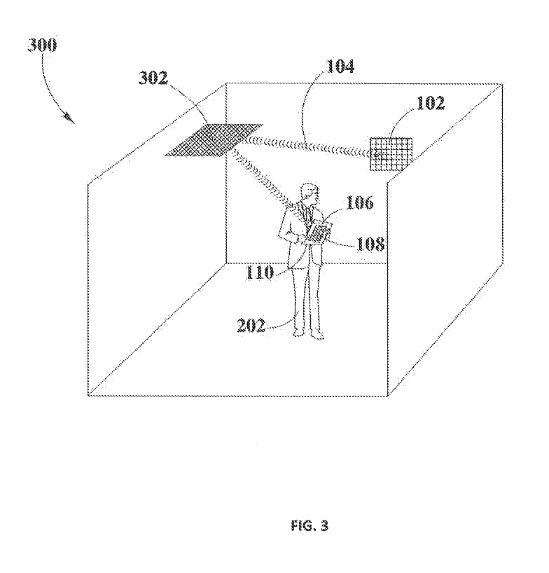

FIG. 3 illustrates a wireless power transmission 300 using pocket forming and a reflector 302, according to an embodiment. Transmitter 102 can be purposely aimed at reflector 302, so that the generated RF waves 104 can be accurately and efficiently reflected towards the location of electronic device 110, which can be under user 202 operation or it can be just resting over any room furniture (not shown in FIG. 3). According to an embodiment, reflector 302 can be made of metallic materials such as steel, aluminum, copper, and the like, in order to reflect close to 100% of the RF waves 104 power directly towards receiver 108 in electronic device 110 for the generation of pockets of energy 106 that provide suitable charge or power. In another embodiment, reflector 302 can be capable of increasing the power of reflected RF waves 104 by a factor between about 2 and 3, thereby enhancing the charging efficiency of electronic device 110 and improving the spatial 3D pocket formation.

Reflector 302 can be a sheet of metal exhibiting a rectangular shape within suitable dimensions, preferably between 1 and 2 ft2. Surface area of reflector 302 may vary according to the dimensions of RF waves 104 which typically may be less than 1 ft. wide. In another embodiment, reflector 302 can include a printed circuit board (PCB) with a metal layer that can bounce off RF waves 104 generated by transmitter 102.

Reflector 302 can be positioned in the room ceiling in order to avoid as many obstacles as possible when reflecting RF waves 104 towards electronic device 110. However, other locations or structures across the room can also be considered. For example, reflector 302 may be positioned in the walls or floor, relative to the location of electronic device 110 and transmitter 102. Reflector 302 can also be slightly tilted according to a desired reflection path relative to the location of electronic device 110. In addition, reflector 302 may be painted or covered according to the color, texture or decoration of room walls, ceiling, or floor.

Mounting methods of reflector 302 in room ceiling, walls, or floor can include four screws at each corner of reflector 302, in addition to suitable adhesives or glues that may securely install reflector 302 relative to transmitter 102 and electronic device 110.

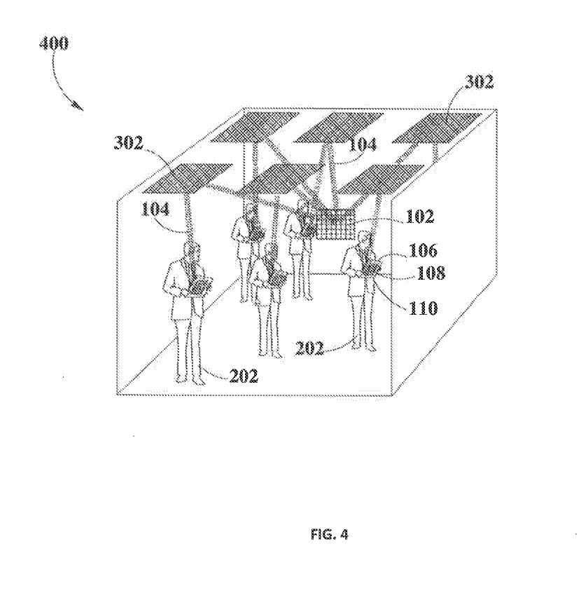

Referring now to FIG. 4, a wireless power transmission 400 may utilize pocket forming in combination with a plurality of reflectors 302, according to an embodiment. Two or more reflectors 302 can be positioned in the room ceiling in order to reflect transmitted RF waves 104 into different areas across the room. According to some aspects of this embodiment, transmitter 102 can he purposely aimed at any of the six reflectors 302, as shown in FIG. 4, for allowing the reflection of RE waves 104 towards one or more locations in the room where electronic device 110 or a user 202 holding said electronic device 110 may be positioned. As previously explained, receiver 108 incorporated into electronic device 110 can receive reflected RF waves 104 for the generation of pockets of energy 106 that can suitability charge electronic device 110.

In another embodiment, a plurality of transmitters 102 can be installed in the room wall so as to match the number of reflectors 302 installed in the ceiling. In such case, one transmitter 102 may correspond to one reflector 302, where all transmitters 102 can simultaneously generate RF waves 104 aimed at corresponding reflectors 302, which can then redirect these RE waves 104 across the room for providing pockets of energy 106 to a plurality of electronic devices 110 at the same time. This can also allow continuous charging for a user 202 who may be utilizing electronic device 110, while being in constant movement across the room.

In FIG. 4, a plurality of reflectors 302 can also be combined with a single transmitter 102 capable of producing multi-pocket forming. In such case, transmitter 102 can generate multiple RF waves 104 aimed at reflectors 302, which can then redirect these RF waves 104 across the room, thereby powering one or more electronic devices 110 at the same time.

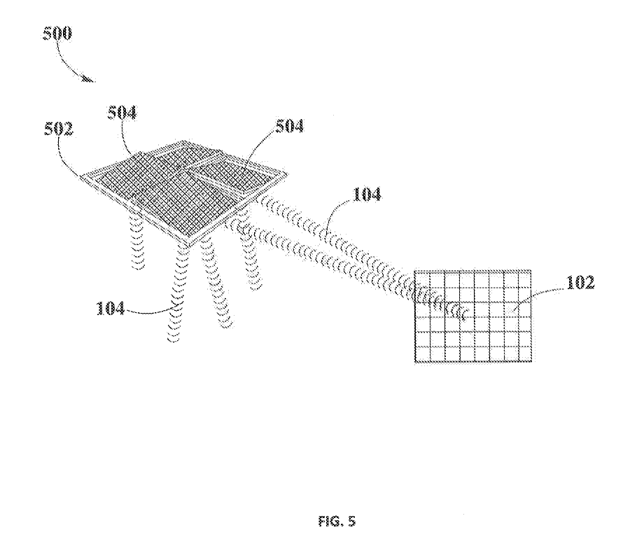

FIG. 5 shows a reflector structure 500 that can be used in wireless power transmission 300, according to an embodiment. Similarly to reflector 302 in FIG. 3, reflector structure 500 can be installed in the room ceiling in order to redirect the formation of pockets of energy 106 according the position of electronic device 110. This reflector structure 500 may include a frame 502 enclosing individual two or more reflector pieces 504 which can be angled or tilted depending on the desired direction of the reflected RF wave 104. For example, each of these reflector pieces 504 can be differently angled relative to transmitter 102 to cover each of the four quadrants of the room. Depending on which reflector piece 504 the transmitted waves 104 hit, reflected waves 104 can he scattered in four different quadrants according to the configuration of each reflector piece 504 in reflector structure 500.

According to some aspects of this embodiment, reflector structure 500 can exhibit a suitable dimension of about 2 ft×2 ft, which can translate into a 1 ft2 surface area for each reflector piece 504. Likewise to reflector 302, these reflector pieces 504 can be made of suitable metal materials such as copper, steel and aluminum capable of reflecting most of the signal power of RF waves 104 towards receiver 108 in electronic device 110, in this manner achieving a more efficient power generation and battery charging.

Although reflectors 302 and reflector pieces 504 are shown within respective shapes, features and geometric relationships, other geometric relationships, features and shapes may be contemplated.

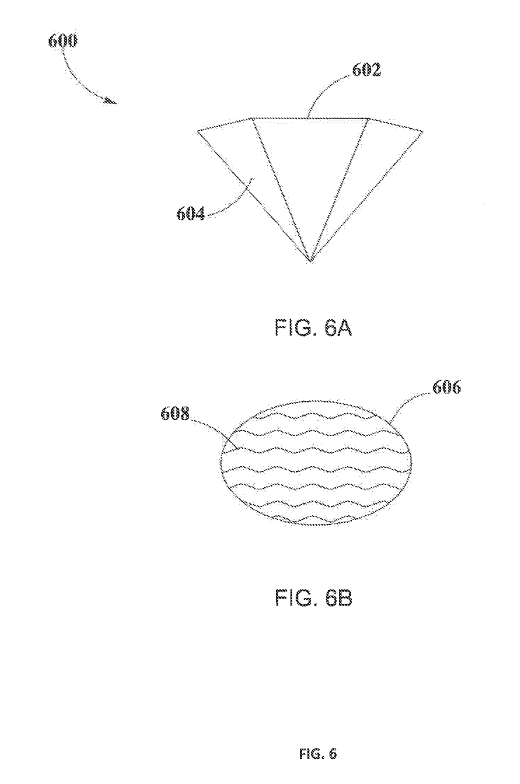

FIG. 6 shows reflector configurations 600 that can be applied in reflectors 302 and reflector pieces 504, according to an embodiment. FIG. 6 A shows a pyramid configuration 602 with three or more faces 604. Compared to pyramid configuration 602, reflectors 302 and reflector pieces 504 in wireless power transmission 300, 400 can typically exhibit a flat surface which can provide only one dedicated or specific angle of reflection. Reflectors 302 and reflector pieces 504 incorporating pyramid configuration 602 can offer more than one angle of reflection depending on which face 604 the transmitted RE waves 104 hit. In this way, RE waves 104 can be reflected in more than one direction, without requiring moving or tilting reflector 302 and reflector pieces 504.

FIG. 6 B shows an oval-shape configuration 606 that can also be applied to reflector 302 and reflector pieces 504 in order to reflect RF waves 104 in more than one direction, without requiring any change their position or orientation. This uneven oval-shape configuration 606 can include a plurality of curves 608 which may form an uneven surface texture compared to the typically smooth surface of reflector 302 and reflector pieces 504 used in wireless power transmission 300, 400. When transmitted RF waves 104 strike a reflector 302 or reflector piece 504 using oval-shape configuration 606, the uneven surface texture can scatter the reflected RF waves 104 in different directions that may correspond the location of electronic device 110.

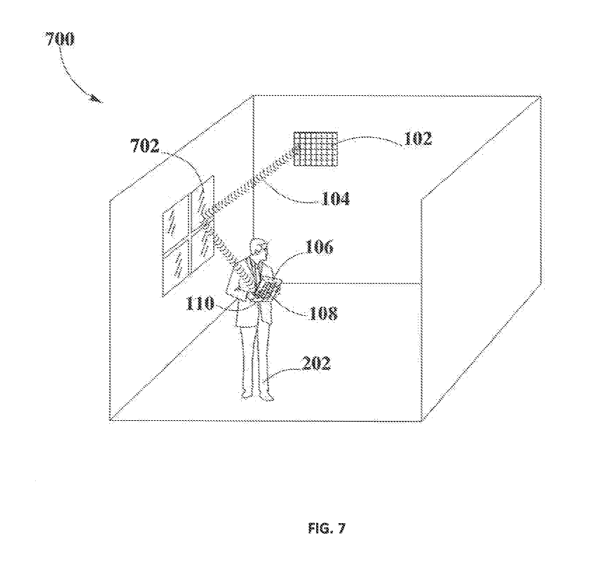

Referring now to FIG. 7, a wireless power transmission 700 can employ pocket forming in conjunction with a window reflector 702 for powering electronic device 110, according to an embodiment. Window reflector 702 can be formed when a commercially available insulating film is installed in a room window, where this insulating film can include a flexible and transparent metallic layer capable of reflecting RF waves 104. According to some aspects of this embodiment, transmitter 102 can be purposely aligned towards window reflector 702, which can then redirect RF waves 104 to receiver 108 in electronic device 110 for the generation of pockets of energy 106 capable of charging electronic device 110. In another embodiment, the metallic layer included in window reflector 702 can be configured for allowing certain wavelengths of communication signals, such as satellite or cellphone, to pass through window reflector 702, while reflecting nearly 100% of RF waves 104 from transmitter 102 towards electronic device 110 for charging.

In other embodiments, metallic paint can also be applied, to different structures in the room to act as reflectors of RF waves 104, where the reflection efficiency may vary according to the metallic concentration in the paint composition.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method for transmitting wireless power, comprising:
generating two or more RF waves from a transmitter with at least two RF transmit antennas;
forming controlled constructive interference patterns from the generated RF waves;
accumulating energy or power in the form of constructive interference patterns from the RF waves to form pockets of energy;
converging the pockets of energy in 3-d space to a targeted electronic device;
redirecting the transmitted RF waves converging the pockets of energy in 3-d space to the targeted electronic device by a reflector for charging or operating the targeted electronic device with the pockets of energy.

2. The method for transmitting wireless power of claim 1, further the method of forming controlled destructive interference patterns from the generated RF waves and accumulating energy or power in the form of destructive interference patterns from the RF waves to form null-spaces of energy between each pocket of energy and further including at least one transmitter aiming pockets of energy at the reflector to redirect the transmitted RF waves forming the pockets of energy to a receiver embedded or operatively coupled to the targeted electronic device.

3. The method for transmitting wireless power of claim 2, further including a flat panel reflector mounted in predetermined locations in the ceiling, walls or floor of a room to accurately and efficiently reflect pockets of energy toward the receiver for charging or operating the targeted electronic device.

4. The method for transmitting wireless power of claim 1, wherein the reflector is made of metallic materials including steel, aluminum, copper or similar materials to reflect approximately 100% of the pockets to a predetermined locations within the 3-d space.

5. The method for transmitting wireless power of claim 1, wherein the reflector increases the power of the reflected RF waves forming the pockets of energy a factor approximately 2 and 3 times and further enhancing the charging efficiency of the targeted electronic device and improving the spatial 3D pocket of energy formation.

6. A system for transmitting wireless power, comprising:
a transmitter having at least two RF antennas in an array for generating pockets of energy;
a receiver embedded in a targeted electronic device for receiving the pockets of energy;
a reflector of predetermined dimensions with a surface area of approximately between 1 and 2 feet squared wherein the pockets of energy are redirected to the targeted electronic device.

7. The system for transmitting wireless power of claim 6, wherein the transmitter generates two or more RF waves through at least two RF transmit antennas to create constructive interference patterns from the RF waves to form predetermined pockets of energy and wherein the reflector redirects the pockets of energy toward one or more locations in a room where targeted electronic devices are positioned.

8. The system for transmitting wireless power of claim 6, wherein the reflector includes a frame enclosing individual reflector components configured to be angled or tilted depending on the predetermined direction relative to the transmitted pockets of energy in 3d spaces for charging or operating the electronic device.

9. The system for transmitting wireless power of claim 8, wherein the reflector components are angled relative to the transmitter to cover each of a four quadrants of a room.

10. The system for transmitting wireless power of claim 7, further wherein the reflector is a pyramid configuration with at least three faces offering more than one angle of reflection depending on the face transmitting the RF waves in one or more predetermined directions without requiring moving or titling the reflector or reflector components.

11. A system for transmitting wireless power, comprising:
a transmitter for generating two or more RF waves having at least two RF transmit antennas to form controlled constructive interference patterns from the generated RF waves;
a micro-controller within the transmitter controlling the constructive interference patterns of generated RF waves for pocket-forming to accumulate pockets of energy in predetermined areas or regions in space;
a receiver mounted within a targeted electronic device with at least one antenna to receive the accumulated pockets of energy converging in 3-d space to the targeted electronic device;
a communication network connected to transmitter and receiver for determining the areas or regions in space to receive the pockets of energy from the transmitter through an array of antennas for charging or operating the targeted electronic device; and
a reflector having one or more angles of reflection for directing pockets of energy to the targeted electronic device within a space.

12. The system for transmitting wireless power of claim 11, wherein the reflector is made of materials generally reflecting 100% of the RF waves and having a predetermined squared footage to reflect the transmitter generated RF waves forming the constructive interference patterns creating the pockets of energy in the direction of the receiver to charge or power the electronic device.

13. The system for transmitting wireless power of claim 11, wherein the reflector is generally configured in a flat panel mounted on a wall, ceiling or floor and is capable of being painted or covered according to a color, texture or decoration of the room walls, ceiling or floor.

14. The system for transmitting wireless power of claim 11, wherein the reflector is a plurality of reflectors positioned within a room ceiling in order to reflect transmitted RF waves into different areas across the room.

15. The system for transmitting wireless power of claim 11, wherein the transmitters are a plurality of transmitters and the number of reflectors installed within a space are a plurality of reflectors matching the number of transmitters where all of the transmitters simultaneously generate RF waves are aimed at corresponding reflectors to redirect RF waves across the space for providing pockets of energy to electronic devices equal to the number of reflectors

16. The system for transmitting wireless power of claim 11, wherein the antennas operate in frequency bands of 900 MHz, 2.5 GHz or 5.8 GHz bands.

17. The system for transmitting wireless power of claim 11, wherein the reflector are a plurality of reflectors combined with a single transmitter to generate multiple RF waves aimed at the plurality of reflectors that redirect the multiple RF waves across the space to power one or more electronic devices.

18. The system for transmitting wireless power of claim 11, wherein the reflector or reflector components are configured in a number of different geometric relationships or shapes capable of transmitting RF waves to the targeted electronic devices.

19. The system for transmitting wireless power of claim 11, wherein the reflector is an oval-shape configuration in order to reflect RF waves in more than one direction without requiring any change in the position or orientation of the reflector and further including a plurality of curves to form an uneven surface compared to a smooth surface to scatter reflected RE waves in different directions that may correspond to the locations of electronic devices.

20. The system for transmitting wireless power of claim 11, wherein the reflector is incorporated into the insulating film installed within a room window comprised of a transparent metallic layer capable of reflecting RF waves to redirect RF waves to the receiver in the electronic device or wherein the reflector is a metallic concentration within a paint composition to reflect and redirect RF waves to the receiver.
